(19) United States
(12) Patent Application Publication
(10) Pub. No.: US 2009/0217828 A1
(43) Pub. Date: Sep. 3, 2009

(54) UNIT FOR COMPACTING HOLLOW BODIES

(76) Inventor: Hermann Scharfen, Bochum (DE)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/297,313

(22) PCT Filed: Apr. 16, 2007
(86) PCT No.: PCT/EP2007/003329

§ 371 Date: Oct. 16, 2008

(30) Foreign Application Priority Data
Apr. 21, 2006 (DE) 10 2006 019 163.3
Jul. 18, 2006 (DE) 10 2006 033 615.1

(51) Int. Cl. B30B 9/32; B02C 4/08; B02C 4/40

(52) U.S. Cl. 100/98 R; 241/236; 241/222; 100/327

(57) ABSTRACT

In order to simplify the assembly and to achieve an improved compaction, the unit for compacting hollow bodies, for instance for non-returnable bottles, comprises a roller which can be driven, (1) featuring a plurality of protruding elements and a non-driven counter bearing (9′, 9′, 9″) with at least one recess, and is constructed in such a manner that the protruding elements, upon rotation of the roller, temporarily and at least partly engage with the recess and a deflector (6) which is downstream from the counter bearing in a rotational direction of the operated roller. Said deflector features at least one recess in which the protruding elements of the roller (1) temporarily engage during operation, at least partially.

The present invention relates to a unit for compacting hollow bodies, such as glass, plastic or metal containers, for example drinks containers, which undergo permanent deformation during compaction. The compaction achieved results in a permanent reduction in size, so that the compacted objects can be cheaply stored and more easily transported, while at the same time destroying any control markings present on the hollow body.

Such hollow body containers are used, for example, for drinks containers of plastic or metal, of which large amounts must be handled. These containers are often not introduced into the proper waste disposal cycles for reasons of inconvenience. This is why there has been legislation, to counteract this tendency, to make payment of a deposit obligatory for each drinks container. Each drinks container is additionally provided with control markings. When the drinks container is returned, the payable deposit is refunded. To prevent repeated returning of a drinks container, the drinks container should be destroyed and the control markings applied should be made invalid.

From DE 103 25 368 B4, a compacting unit is known, which is equipped with two rollers having erect, hook-like blades for feeding and interweaving the compressed object, and which uses the parallel, synchronously counteracting arrangement of the rollers to carry out the compacting process. In this context, “compacting” refers to a process, wherein the hollow body is compressed, perforated and, if necessary, interwoven or crimped together by the perforating process in such a way that the thus compressed hollow body permanently remains in its compressed form.

In such units it often happens that the walls of the hollow body are pulled apart again when the compressed hollow body exits the apparatus, since the hooks of the rollers turn outwards from the center line of the rollers and the blades are driven apart. This results in the volume of the empty containers being increased again for storage or transportation.

The present invention is intended to simplify the construction of a compacting unit. Pulling apart of the compressed and interwoven wall sections of the hollow body should also be prevented.

This object is achieved by compacting units according to claims 1 and 9, and a compacting machine according to claim 11. Preferred embodiments are defined in the dependent claims.

The present invention enables a compacting unit which is cheap to manufacture and easy to maintain. For this purpose, the compacting unit only needs a drivable roller with protruding elements. The elements cooperate with a non-driven counter-bearing in such a way that a hollow body, such as a plastic bottle or a drinks can, is fed and squashed by the rotation of the roller. For this purpose a gap is formed between the surface of the counter-bearing and the roller in correspondence to the hollow body to be compacted. The elements can preferably be formed as blades or teeth.

To achieve invalidation or partial destruction of the hollow body, the protruding elements of the roller partially extend into at least one recess of the counter-bearing in a rake-wise manner during rotation, whereby a fed-in hollow body is perforated at this position. Perforation is necessary, in particular, to evacuate air or liquid usually contained in the hollow body. Downstream from the counter-bearing in the rotation direction, a stripper is arranged for separating the compacted hollow bodies from the roller. For this purpose the stripper also has at least one recess into which the elements of the roller at least partially extend in a rake-wise manner during rotation. The distance between the elements and the counter-bearing or the stripper respectively during the engagement of the elements with the counter-bearing as well as with the stripper should be chosen such that they do not touch. To achieve reliable stripping, the distance between the elements of the roller and the stripper should be small enough, however, not to allow a compacted hollow body to pass between the roller and the stripper.

Since such compacting units are not only operated by skilled personnel, it is entirely possible that unsuitable objects may be inserted. For example, it is entirely possible for a non-compactable object, such as a piece of rock contained in a hollow body, to pass into the unit.

According to one embodiment of the present invention, in this case, the counter-bearing is moveable from a first into a second position. A non-compactable object can be, for example, a piece of rock or a screw. By having the counter-bearing make such an evasive movement, the wear and tear is reduced when unsuitable objects are inserted and destruction of the compacting unit is advantageously avoided. In the second position the distance between the roller and the counter-bearing should be enlarged from the first position in such a way that the non-compactable object can pass through the unit. The second position can thus be at a variable distance from the first position depending on the size of each inserted, non-compactable object. After the non-compactable object has passed through the unit, the counter-bearing should be shifted back into the first position to return to the normal operating condition. To achieve this, all the usual drives are suitable, for example, a corresponding electric motor can be used to shift the counter-bearing both to the second position and back into the first position. Preferably drives working according to the spring principle can also be used to shift the counter-bearing.

It is particularly preferred if the counter-bearing is moveable from the first position into the second position under a spring load. This ensures automatic movement of the counter-bearing when a non-compactable object passes through the unit. After the non-compactable object has passed through the compacting unit, the counter-bearing moves back into the first position. The spring force should be chosen such that the counter-bearing remains in the first position during ordinary operation and only moves to the second position when an unsuitable object is inserted. Particularly preferably, one or more plastic rod springs of a compressible material can be used to provide the spring force.

According to a preferred embodiment of the invention, the counter-bearing is a counter plate. Such an embodiment allows the compacting unit to be cheaply manufactured. Preferably, the counter plate has spaced grooves into which the protruding elements of the roller extend. Herein, the grooves should be formed in at least the area of the counter plate which comes into engagement with the protruding elements of the roller. Preferably the grooves are formed along the entire counter plate. This further simplifies manufacture. Such grooves can be formed by machining the counter plate, for example. It is of course also possible to apply finger-like strips on the base plate to thus form grooves between them.

Instead of the counter plate, preferably also a counter roller or counter roll may be used, which does preferably, however, not need a drive and is therefore not driven. Also the counter roller should preferably have corresponding grooves, as explained above, arranged along the circumference of the counter roller.

Preferably, axially-spaced elements are arranged on the roller, which extend into a plurality of recesses in the counter-bearing and stripper during operation. By these means, perforation of the hollow body can be achieved in plural places, which is advantageous. It is further preferred if a plurality of sequentially spaced elements is formed in the circumferential direction on the roller to further improve perforation.

According to an embodiment of the invention, the roller has individual disk-like segments sequentially arranged on a common shaft in the axial direction. These disk-like segments each have at least one protruding element. According to this preferred embodiment it is possible to exchange individual segments of the roller in a simple manner in the case of wear. The replacement of the entire roller can therefore be avoided. For this purpose, the segments should be provided with a through-hole correspondingly formed in an anti-twist manner, so that they can be fixed on the shaft. Preferably, the segments should each have a plurality of sequentially spaced elements in the circumferential direction, as explained above.

Particularly preferably, the protruding elements are formed as hook-like blades. This is to further improve the perforating properties of the compacting unit.

In a further aspect of the invention according to claim 9, a unit for compacting hollow bodies comprises at least one drivable roller with a plurality of protruding elements, and a counter-bearing with at least one recess, which are arranged in such a way that the protruding elements at times at least partially extend into the recesses during rotation of the roller, wherein the roller and/or the counter-bearing are moveable from a first position into a second position.

Also for this aspect of the invention the initially mentioned advantages with respect to the avoidance of wear and tear apply when unsuitable objects are inserted. The counter-bearing for compacting can also be driven in the present instance, even though this is not necessary. The counter-bearing is preferably a counter roller or a counter roll.

Particularly preferably, again, a stripper is provided downstream from the counter-bearing in the rotation direction of the roller. The stripper has at least one recess, into which the protruding elements of the roller at least partially extend at times during operation. The above mentioned preferred embodiments of the invention can also be applied to the present aspect of the invention in an analogous fashion.

A compacting machine with a unit for compacting hollow bodies as described above comprises at least one of the subsequently mentioned elements: feeding means, drive, control means, detection means, housing, collection container.

A corresponding feeding means comprises an introduction apparatus and any moving means, to feed an introduced hollow body to the compacting unit. To enable refunding of the corresponding deposit, a detection means can be provided. This detection means detects whether a hollow body has been introduced and further the type of hollow body concerned. This is how the corresponding deposit to be refunded may be determined. The detection means should also be able to detect introduced non-compactable objects and should then suspend operation of the compacting machine. The control means is for controlling the sequence of the compacting process and can be formed by all common control means, such as a programmable logic controller (PLC) or a microprocessor control. In particular, the control means controls the drive for driving the roller. This can preferably be an electric motor. After compacting has been carried out, the compacted hollow body is received in the collection container. In particular when also glass containers are compacted or shredded, a housing is advantageous, since no glass shards are able to pass into the environment.

Since during extended operating periods or during the summer months the compacting machine can get warm, there can be germ formation within the compacting machine and therefore a substantial smell can develop, due to the liquid residues exiting from the hollow bodies. Since such compacting machines are usually operated within a closed environment, such as the interior of a shop, a smell is undesirable.

The compacting machine can therefore preferably comprise a cooling unit. The cooling unit can be formed as an air cooling system, for example, for supplying cooled air to the housing of the compacting machine during operation. Since a convection effect usually arises due to the cooled air, it uniformly flows through the machine. It is also conceivable, however, to provide adjustable nozzles for cooling the roller and the counter-bearing, for example, to a particular degree. As an advantageous side-effect, cooling of the drive motors of the compacting machine can also be achieved by the air cooling. Alternatively it is conceivable to directly cool the compacting unit, such as by cooling the roller and the counter-bearing by means of corresponding cooling elements, since it is here that germ formation must be reckoned with in particular. To avoid an undesirable smell, the housing of the compacting machine should be sealed with respect to the environment. Venting could then be carried out by means of a venting duct.

Alternative to cooling, the compacting machine can further preferably be provided with an uncooled air flow. For this purpose, for example, a suitable blower could blow ambient air into the compacting unit, which is then vented via a corresponding venting duct “out into the open”. In this case the machine should be particularly well sealed. While by the use of uncooled air, there is only a small reduction in germ formation, the controlled ventilating and venting of the machine results in no undesirable smell in the surrounding areas, such as in the interior of a shop, where the machine is deployed. Since there is only a small convection effect, when uncooled air flows through, preferably baffles or adjustable nozzles should be arranged in the machine, in particular, to ensure good air flow.

Embodiments of the invention are illustrated in the drawings, wherein:

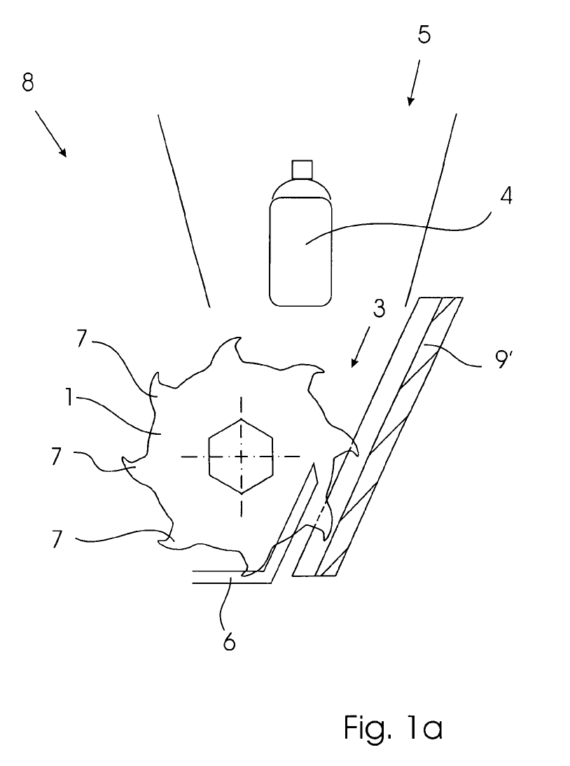

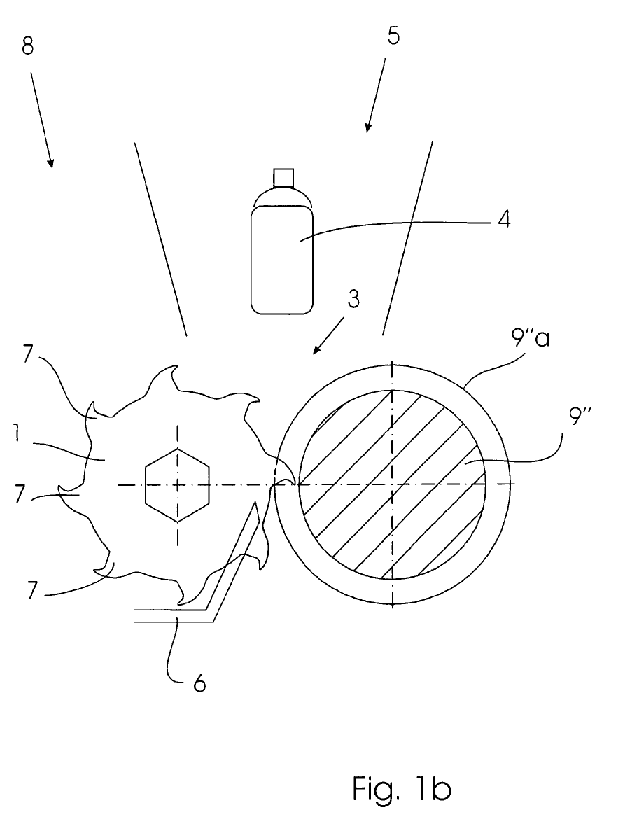

FIGS. 1a and b show embodiments of the invention in a schematic side view,

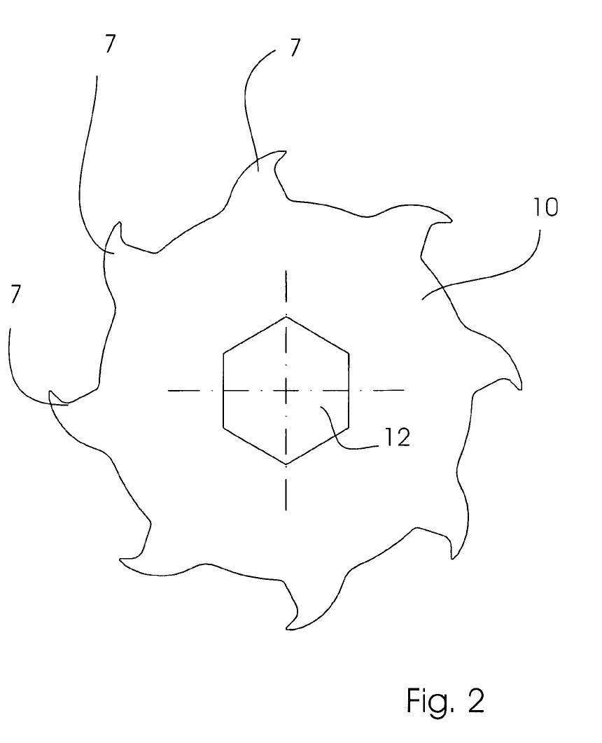

FIG. 2 shows an exemplary embodiment of a cutting disk with hook-like blades in a side view for use in a unit for compacting according to the present invention,

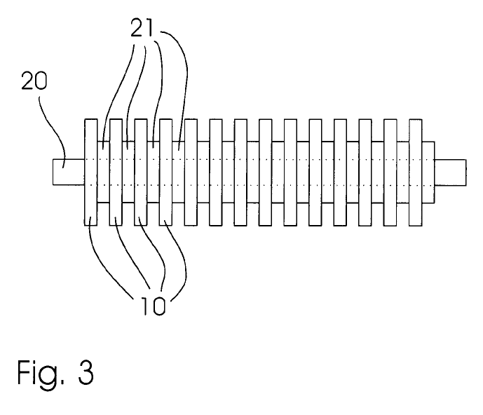

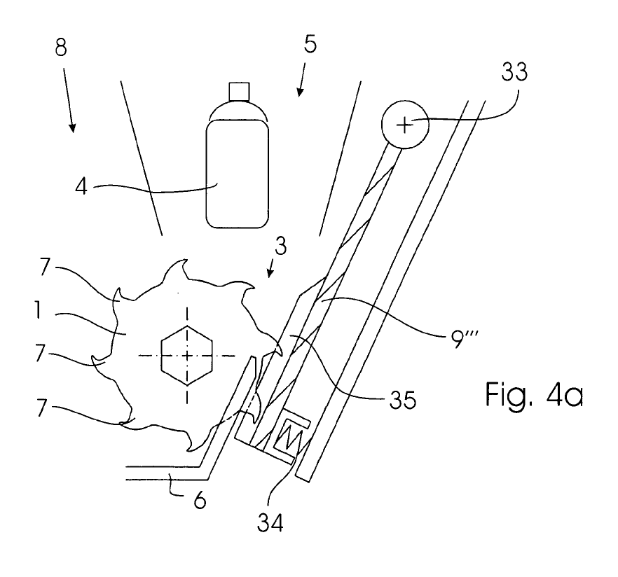

FIG. 3 shows an exemplary embodiment of a roller for use in a compacting unit according to the present invention,

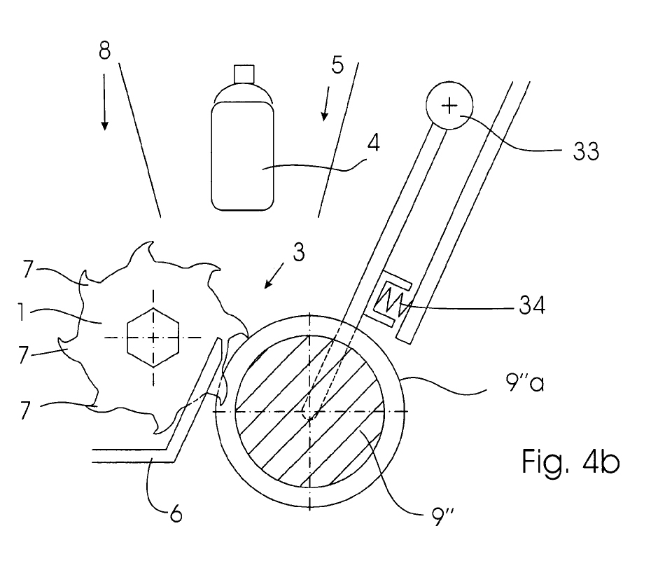

FIGS. 4a and b show further exemplary embodiments of the invention in a schematic side view,

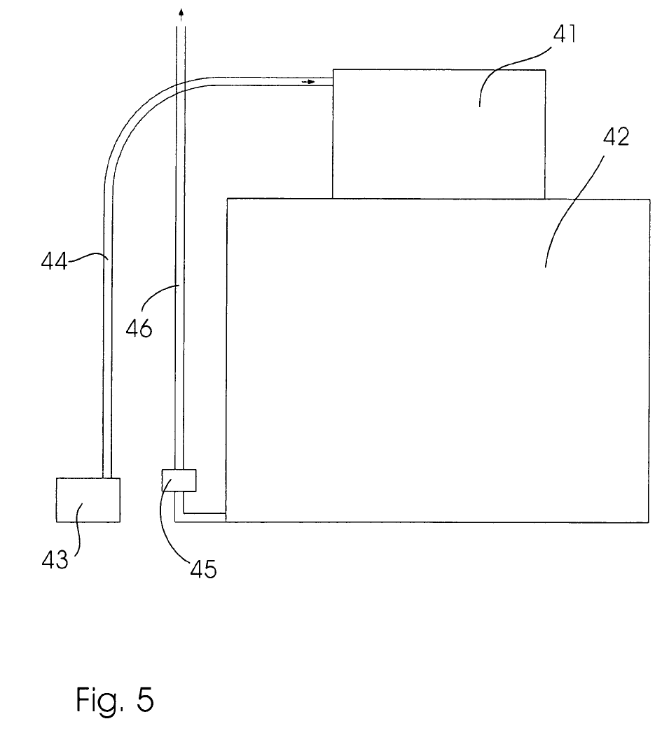

FIG. 5 is a schematic side view of an exemplary embodiment of a compacting unit.

With reference to FIG. 1a, an exemplary embodiment of a unit for compacting 8 is shown. In FIG. 1a, a roller 1 driven by a drive unit (not shown) with erect, hook-like blades 7, and a counter plate 9′ formed as a grooved wall, wherein blades 7 of roller 1 extend into the grooves are shown. The grooves extend along the longitudinal axis of counter plate 9′ in the side facing roller 1. Compressed object 4, here a PET bottle, is introduced into gap 3 of introduction apparatus 5 and fed-in by the rotation in the direction shown. Compressed object 4 is squashed in gap 3, and the walls of compressed object 4 are perforated by hook-like blades 7. At the same time, the opposing outer walls of compressed object 4 are interlocked in a claw-wise fashion. To strip compressed object 4, a stripper 6 with grooves formed in it is arranged on the outlet side of the apparatus. In a similar fashion to counter plate 9′, blades 7 of roller 1 extend into the grooves of stripper 6.

In a similar way, FIG. 1b shows a further exemplary embodiment of a compacting unit 8. Counter plate 9′ cooperating with roller 1 in the preceding embodiment here is replaced by a counter roller 9″ formed as a grooved roller having grooves extending in the circumferential direction, indicated with outer line 9″a. Preferably, counter roller 9″ is not driven, however. Counter roller 9″ can be adapted to be rotatable, however, to improve the compacting process. In this case counter roller 9″ can be moved by compressed object 4 introduced into gap 3.

A cost-saving factor is, in particular, that the rollers are not manufactured as a single, integral unit, but consist of disks 10, which are provided with blades and are assembled on a common shaft together with spacing disks. An exemplary embodiment of such a cutting disk 10 is shown in FIG. 2. Disk 10 is of hardened steel and has tooth-like cutting elements 7 integrally formed on its circumference. To fix disk 10 on a roller shaft in an anti-twist manner, it has a hexagonal through-hole 12. This hexagonal through-hole 12 can, of course, also be in another form, as long as it provides anti-twist fixing, for example, a polygonal through-hole.

An exemplary embodiment of a roller 20 with mounted cutting disks 10 is shown in FIG. 3. Cutting disks 10 are, as described above, mounted on roller 20 while spaced by spacer disks 21. The thickness of spacer disks 21 should be chosen according to the perforation interval of compressed object 4. By this modular configuration, maintenance of the compacting machine can be improved, in particular, since worn-out disks 10 can be individually exchanged without having to exchange the entire roller 20. During the operation for compacting drinks containers, it can usually not be avoided that unsuitable objects sometimes contained in the containers, such as pieces of rock or screws, are passed into the compacting unit. Since also here the wear caused thereby only arises in a very small area and the corresponding cutting disks 10 can be easily exchanged, the modular structure is advantageous also in this respect.

FIGS. 4a and 4b show further exemplary embodiments of the invention. The exemplary embodiments shown in FIGS. 4a and 4b are analogous to the exemplary embodiments shown in FIGS. 1a and 1b. Corresponding components are therefore indicated with the same reference numerals. As can be seen from FIG. 4a, counter plate 9′″ formed as a grooved wall only has correspondingly formed grooves 35 in the area of the interference with the hook-shaped blades 7 of roller 1. Further, counter plate 9′″ is pivotably supported by a bearing 33. A compressible plastic spring 34 provides a pressing force so that the hook-shaped blades 7 of roller 1 are in engagement with the grooves of counter plate 9′″. Spring 34 is adjusted in such a way that in the case of the insertion of a non-compactable unsuitable object, counter plate 9′″ pivots out of the way to let the unsuitable object pass. By these arrangements, damage to roller 1 or counter plate 9′″ can be avoided.

In a similar manner, counter roller 9″ of FIG. 4b, formed as a grooved roller, is also pivotably supported about bearing 33. Again a plastic spring 34 is provided ensuring that counter roller 9″ contacts roller 1. Again, in the case of the insertion of an unsuitable object, counter roller 9″ can move out of the way.

FIG. 5 shows a schematic view of an exemplary embodiment of a compacting machine. The compacting machine comprises a compacting unit 41 with a collection container 42 arranged beneath it for receiving the compacted compressed objects 4. A corresponding insertion opening for the object 4 to be compressed is of course present on the compacting unit 41, but is not shown here. The compacting machine also has further elements, such as a microprocessor control and corresponding drives which are not shown for reasons of clarity. To avoid germ formation in the compacting machine, a cooling unit 43 is connected with compacting unit 41 via a supply duct 44. The cooling unit is configured in such a way that cooled air is fed via supply duct 44 to the compacting unit. The cooled air flows through compacting unit 41 and collection container 42 due to convection and is then evacuated by a blower 45 at the collection container. The air is then exhausted into the open air via an exhaust duct 46.

With these arrangements it is possible, by corresponding cooling of compacting unit 41 and collection container 42, to reduce germ formation within the compacting machine. To avoid an undesirable smell, the cooled air correspondingly introduced into compacting unit 41 is evacuated at collection container 42 and exhausted into the open. The compacting machine should of course be sealed for this purpose, so that the air introduced into compacting unit 41 only leaves the machine via exhaust duct 46.

1-12. (canceled)

13. A unit for compacting hollow bodies, comprising
a drivable roller including a plurality of protruding elements;
a non-driven counter-bearing including at least one recess, configured such that the protruding elements at least partially extend into the recess at times during rotation of the roller; and
a stripper downstream of the counter-bearing in the rotation direction of the roller during operation that includes at least one recess, in which the protruding elements of the roller at least partially extend at times during operation.

14. The unit for compacting according to claim 13, wherein the counter-bearing is moveable from a first position to a second position, if a non-compactable object is introduced into the unit.

15. The unit for compacting according to claim 14, wherein the counter-bearing is moveable from the first position to the second position in a spring-loaded manner.

16. The unit for compacting according to claim 13, wherein the counter-bearing is a counter plate.

17. The unit for compacting according to claim 13, wherein the counter plate includes spaced grooves or finger-like elements in a side-by-side relationship in the axial direction of the roller, into which the protruding elements extend.

18. The unit for compacting according to claim 13, wherein the counter-bearing is a non-driven counter roller.

19. The unit for compacting according to claim 13, wherein the roller includes individual disk-like segments that are arranged on a common shaft in the axial direction in a side-by-side relationship and each including at least one protruding element.

20. The unit for compacting according to claim 13, wherein the protruding elements are formed as hook-like blades.

21. A compacting machine, comprising:
a unit for compacting hollow bodies according to claim 13; and
at least one of the following elements:
feeding means, drive, control means, detection means, a current supply, a housing, a collection container.

22. The compacting machine according to claim 21, further comprising a cooling means.

23. A unit for compacting hollow bodies comprising:
a drivable roller including a plurality of protruding elements;
a counter-bearing including at least one recess, configured such that the protruding elements at least partially extend into the recess at times during rotation of the roller;
wherein the roller and/or the counter-bearing is/are moveable from a first position to a second position.

24. The unit for compacting according to claim 23, further comprising a stripper downstream from the counter-bearing in operation in the rotation direction of the roller during operation and that includes at least one recess into which the protruding elements of the roller at least partially extend at times during operation.

25. A compacting machine, comprising:
a unit for compacting hollow bodies according to claim 24; and
at least one of the following elements:
feeding means, drive, control means, detection means, a current supply, a housing, a collection container.

26. The compacting machine according to claim 25, further comprising a cooling means.
